(19) United States
(12) Patent Application Publication
(10) Pub. No.: US 2011/0313958 A1
(43) Pub. Date: Dec. 22, 2011

(54) SYSTEM AND METHOD FOR EMPIRICAL ENSEMBLE-BASED VIRTUAL SENSING OF PARTICULATES

(75) Inventor: Davide Roverso, Tistedal (NO)

(73) Assignee: INSTITUTT FOR ENERGITEKNIKK, Kjeller (NO)

(21) Appl. No.: 13/201,551

(22) PCT Filed: Feb. 16, 2010
(86) PCT No.: PCT/NO2010/000058

§ 371 Date: Sep. 8, 2011

Related U.S. Application Data
(60) Provisional application No. 61/153,179, filed on Feb. 17, 2009.
(60) Provisional application No. 61/153,521, filed on Feb. 18, 2009.

(30) Foreign Application Priority Data
Feb. 16, 2009 (NO) 20090736

(51) Int. Cl. G06F 15/18

(52) U.S. Cl. 706/12

(57) ABSTRACT

A virtual sensor system and method for the estimation of an amount or concentration of particulate matter resulting from natural or man made processes comprising two or more empirical models arranged for being trained using empirical data from the processes, for receiving one or more signal input values from one or more sensors of the processes and calculating a signal output value based on the signal input values where the signal output value represents an intermediate amount or concentration of particulate matter. Further a combination function is arranged for receiving the signal output values and continuously calculating the amount or concentration of PM.

### TECHNICAL FIELD

The present invention relates to a method and system for empirical ensemble-based virtual sensing and more particularly to a method and system for virtual particulate sensors for measuring particulates, fine particles of solid or liquid suspended in a gas, where the diameter is less than 10 μm.

### BACKGROUND

Particulates, also known as particulate matter (PM), are fine particles of solid or liquid suspended in a gas. PM can be manmade or natural. PM occur naturally, originating from volcanoes, dust storms, forest and grassland fires, living vegetation, and sea spray. Human activities, such as the burning of fossil fuels in vehicles, power plants and various industrial processes also generate significant amounts of PM.

The composition of PM include magnesium, sulfate, calcium, potassium with or without added organic compounds, particles from the oxidation of gases such as sulfur and nitrogen oxides into sulfuric acid (liquid) and nitric acid (gaseous), ammonium sulfate and ammonium nitrate (both either in dry or in aqueous solution) sulfuric acid (in liquid aerosol droplets, nitric acid (as atmospheric gas) and elemental carbon, EC, also known as black carbon, BC.

Increased levels of PM in the air are linked to health hazards such as heart disease, altered lung function and lung cancer.

PM can be categorized with respect to size, referred to as fractions. As particles are often non-spherical, the most widely used definition is the aerodynamic diameter. A particle with an aerodynamic diameter of 10 μm moves in a gas like a sphere of unit density (1 gram per cubic centimeter) with a diameter of 10 μm. PM diameters range from less than 10 nanometers to more than 10 micrometers. These dimensions represent the continuum from a few molecules up to the size where particles can no longer be carried by a gas.

The notation PM10 is used to describe particles of 10 micrometers or less, PM2.5 is used for particles less than 2.5 micrometers and PM1 is used for particles less than 1 micrometer in aerodynamic diameter

All reference methods allow a high margin of error. These are also sometimes referred to with other equivalent numeric values. Everything below 100 nm, down to the size of individual molecules is classified as ultrafine particles (UFP or UP), e.g. particles from diesel engines are in this range.

Increasingly stringent government regulations regarding emission reduction, monitoring and control require overcoming technical barriers. To reduce the health and environmental impacts of air pollutants the European commission has published a number of directives that place limits on allowable concentrations of air pollutants. The most recent of these, brought into force in June 2008, involves the inclusion of PM2.5 as a regulated pollutant. Prior to this only PM10 was regulated. As a result of this new directive all Member States are obliged to report the annual mean concentrations of PM2.5 in all urban areas by 2010. However, since PM2.5 has not been a regulated pollutant there are far fewer PM2.5 monitoring stations available than for PM10. This means that significant investment is needed to include PM2.5 monitoring at the same level at which PM10 is currently monitored. Currently over 2000 stations in Europe monitor PM10 concentrations, whilst less than 300 stations are available for PM2.5.

In directives 1999/30/EC and 96/62/EC, the European Commission has set limits for PM10 in the air to be e.g. over a 24-hour average max 50 μg/m³. In the USA the EPA (Environmental Protection Agency) strengthened the 24-hour PM2.5 standard from the 1997 level of 65 micrograms per cubic meter (μg/m³) to 35 μg/m³ in 2006. Similar examples can be found in other regions.

In general continuous measurements of PM concentrations can use optical, electrical, and time-of-flight monitors. Such monitors measure size-resolved particle concentrations based on particle numbers, converted to volume concentrations assuming spherical particles and an assumption about particle density; in most air sampling applications, information on particle density is generally not available and assumptions about its value will introduce uncertainties in the resulting mass concentrations estimates.

U.S. Pat. No. 6,829,919 “High-quality continuous particulate matter monitor” is an example of current technology capable of near continuous measurements of PM.

These monitoring technologies are complicated, sometimes slow and expensive as they include devices that measure Tapered Element Oscillating Microbalances (TEOMs), light scattering photometers, beta attenuation monitors, and optical counters. For measuring chemical composition, devices include ion chromatographs for sulfate, nitrate, sodium, and ammonium; inductively-coupled plasma mass spectrometers and graphite furnaces for trace elements and metals; thermal desorption units for organic concentrations; and mass spectrometers for detection of biologically active compounds.

There is thus a need for a precise, low-cost and versatile monitoring solution providing continuous or near continuous measurements of PM.

In general there is a range of situations where available instrumentation is not adequate for measurements, and the following list names the most common ones (As originally proposed by BioComp Systems, Inc. on their webpage http://www.biocompsystems.com/technology/virtualsensors/ind ex.htm 25.07.2008):
1. The physical quantity of interest is not measured on-line. A typical case is when samples are periodically sent to a laboratory for analysis. These could be air, water, oil, or material samples that are analysed to control environmental emission, product quality, or process condition.
2. The available physical sensor is too slow, in particular for use in automatic control.
3. The physical sensor is too far downstream, e.g the end product is continuously monitored to detect production deviations, but where this information comes too late to perform corrective action.
4. The physical sensor is too expensive.
5. There are no means of installing a physical sensor, e.g. no physical space.
6. The sensor environment is too hostile.
7. The physical sensor is inaccurate. Available physical sensors might be subject to either intrinsic inaccuracies or to degradation. Scaling in a Venturi flow-meter is a typical example.
8. The physical sensor is expensive to maintain.

Virtual sensing techniques, also known as soft or proxy sensing, are software-based techniques used to provide feasible and economical alternatives to costly or unpractical physical measurement devices and sensor systems. A virtual sensing system uses information available from other on-line measurements and process parameters to calculate an estimate of the quantity of interest.

A variety of virtual sensing techniques are available and can be classified in two major categories:
Analytical techniques
Empirical techniques

Analytical techniques base the calculation of the measurement estimate on approximations of the physical laws that govern the relationship of the quantity of interest with other available measurements and parameters.

A significant advantage of using analytical techniques based on “first principles” models is that it allows for the calculation of physically immeasurable quantities when these can be derived from the involved physical model equations.

The main weakness of the analytical approach is that it requires accurate quantitative mathematical models in order to be effective. For large-scale systems, such information may not be available or it may be too costly and time consuming to compile. Also, if changes are made to the plant or process, engineering work is needed to update and modify the physical models. Although modelling tools are available to support such model building and maintenance activities, process experts are needed for keeping models updated.

Empirical techniques base the calculations of the measurement estimate on available historical measurement data of the same quantity, and on its correlation with other available measurements and parameters. The historical data of the un-measured quantity can be derived either from actual measurement campaigns with temporarily installed sensor systems, from records of laboratory analyses, or from detailed estimations with complex analytical models that are computationally too expensive to run on-line. The latter is the only possible option if one wants to develop an empirical virtual sensor to estimate immeasurable quantities, for which there is obviously no historical data available.

Empirical virtual sensing is based on function approximation and regression techniques that can be implemented using a variety of statistical or machine learning modelling methods, such as:
Linear regression (see N. R. Draper and H. Smith, 1998. Applied Regression Analysis, Wiley Series in Probability and Statistics)
Weighted least squares regression (see Å. Björck, 1996. Numerical Methods for Least Squares Problems, Cambridge.)
Kernel regression (see J. S. Simonoff, 1996. Smoothing Methods in Statistics. Springer.)
Regression trees (see L. Breiman, J. Friedman, R. A. Olshen and C. J. Stone, 1984. Classification and regression trees. Wadsworth.)
Support Vector regression (see H. Drucker, C. J. C. Burges, L. Kaufman, A. Smola and V. Vapnik, 1997. Support Vector Regression Machines. Advances in Neural Information Processing Systems 9, NIPS 1996, 155-161, MIT Press.)
Neural Network regression (see J. Hertz, A. Krogh, and R. Palmer, 1991. Introduction to the Theory of Neural Computation. Addison-Wesley: Redwood City, Calif.)
Empirical modelling, also known as data-driven modelling, covers a set of techniques used to analyze the condition and predict the evolution of a process from operational data. It has the advantage of neither requiring a detailed physical understanding of the process nor knowledge of the material properties, geometry and other characteristics of the plant and its components, both of which are often lacking in real, practical cases.

The underlying process model is identified by fitting the measured or simulated plant data to a generic linear or non-linear model through a procedure which is often referred to as ‘learning’. This learning process may be active or passive, and involves the identification and embedding of the relationships between the process variables into the model. An active learning process involves an iterative process of minimizing an error function through gradient-based parameter adjustments. A passive learning process does not require mathematical iterations and consists only of compiling representative data vectors into a training matrix.

An important consideration in designing empirical models is that the training data must provide examples of the conditions for which accurate predictions will be queried. That is not to say that all possible conditions must exist in the training data, but that the training data should provide adequate coverage of these conditions. Empirical models will provide interpolative predictions, but the training data must provide adequate coverage above and below the interpolation site for this prediction to be sufficiently accurate. Accurate extrapolation, i.e. providing estimations for data that resides outside of the training data, is either not possible or not reliable for most empirical models.

Empirical models are reliably accurate only when applied to the same, or similar, operating conditions under which the data used to develop the model were collected. When plant conditions or operations change significantly, the model is forced to extrapolate outside the learned space, and the results will be of low reliability. This observation is particularly true for non-linear empirical models since, unlike linear models which extrapolate in a known linear fashion, non-linear models extrapolate in an unknown manner. Artificial neural network and local polynomial regression models are both non-linear; whereas transformation-based techniques such as Principal Components Analysis and Partial Least Squares, are linear techniques. Extrapolation, even if using a linear model, is not recommended for empirical models since the existence of pure linear relationships between measured process variables is not expected. Furthermore, the linear approximations to the process are less valid during extrapolation because the density of training data in these extreme regions is either very low or non-existent.

Artificial neural network models (see J. Hertz, A. Krogh, and R. Palmer, 1991. Introduction to the Theory of Neural Computation. Addison-Wesley: Redwood City, Calif.) contain layers of simple computing nodes that operate as non-linear summing devices. These nodes are highly interconnected with weighted connection lines, and these weights are adjusted when training data are presented to the neural network during the training process. Successfully trained neural networks can perform a variety of tasks, the most common of which are: prediction of an output value, classification, function approximation, and pattern recognition.

Only layers of a neural network that have an associated set of connection weights will be recognized as legitimate processing layers. The input layer of a neural network is not a true processing layer because it does not have an associated set of weights. The output layer on the other hand does have a set of associated weights. Thus, the most efficient terminology for describing the number of layers in a neural network is through the use of the term hidden layer. A hidden layer is a legitimate layer exclusive of the output layer.

A neural network structure consists of a number of hidden layers and an output layer. The computational capabilities of neural networks were proven by the general function approximation theorem which states that a neural network, with a single non-linear hidden layer, can approximate any arbitrary non-linear function given a sufficient number of hidden nodes.

The neural network training process begins with the initialization of its weights to small random numbers. The network is then presented with the training data which consists of a set of input vectors and corresponding desired outputs, often referred to as targets. The neural network training process is an iterative adjustment of the internal weights to bring the network's outputs closer to the desired values, given a specified set of input vector/target pairs. Weights are adjusted to increase the likelihood that the network will compute the desired output. The training process attempts to minimize the mean squared error (MSE) between the network's output values and the desired output values. While minimization of the MSE function is by far the most common approach, other error functions are available.

Neural networks are powerful tools that can be applied to pattern recognition problems for monitoring process data from industrial equipment. They are well suited for monitoring non-linear systems and for recognizing fault patterns in complex data sets. Due to the iterative training process the computational effort required to develop neural network models is greater than for other types of empirical models. Accordingly, the computational requirements lead to an upper limit on model size which is typically more limiting than that for other empirical model types.

Ensemble modelling (see T. G. Dietterich (Ed.), 2000. Ensemble Methods in Machine Learning, Lecture Notes in Computer Science; Vol. 1857. Springer-Verlag, London, UK) also known as committee modelling, is a technique by which, instead of building a single predictive model, a set of component models is developed and their independent predictions combined to produce a single aggregated prediction. The resulting compound model (referred to as an ensemble) is generally more accurate than a single component models, tends to be more robust to overfitting phenomena, has a much reduced variance, and avoids the instability problems sometimes associated with sub-optimal model training procedures.

In an ensemble, each model is generally trained separately, and the predicted output of each component model is then combined to produce the output of the ensemble. However, combining the output of several models is useful only if there is some form of “disagreement” between their predictions (see M. P. Perrone and L. N. Cooper, 1992. When networks disagree: ensemble methods for hybrid neural networks, National Science Foundation, USA) Obviously, the combination of identical models would produce no performance gain. One method commonly adopted is the so-called bagging method (see L. Breiman, 1996. Bagging Predictors, Machine Learning, 24(2), pp. 123-140), which tries to generate disagreement among the models by altering the training set each model sees during training. Bagging is an ensemble method that creates individuals for its ensemble by training each model on a random sampling of the training set, and, in forming the final prediction, gives equal weight to each of the component models. Other more elaborate schemes for ensemble generation and component model aggregation exist, and new ones can be devised.

The use of ensembles to reduce the overall model variance has a close relationship with regularization methods (see A. V. Gribok, J. W. Hines, A. Urmanov, and R. E. Uhrig. 2002. Heuristic, Systematic, and Informational Regularization for Process Monitoring. International Journal of Intelligent Systems, 17(8), pp 723-750, Wiley), which constrain the training of neural network models and their architecture to avoid ill-conditioned problems and achieve a similar control over excessive model variance.

U.S. Pat. No. 5,386,373 “Virtual continuous emission monitoring system with sensor validation” teaches the use of a virtual sensor for emissions, based on a neural network, to control the operations of a plant.

U.S. Pat. No. 6,882,929 “NOx emission-control system using a virtual sensor” teaches the use of a virtual sensor for emissions, based on a neural network, to control the operations of an engine.

U.S. Pat. No. 7,280,987 “Genetic algorithm based selection of neural network ensemble for processing well logging data” teaches a method for generating a neural network ensemble for processing geophysical data, using an algorithm with multi-objective fitness function to select an ensemble with a desirable fitness function value.

Fortuna et al, “Virtual Instruments Based on Stacked Neural Networks to Improve Product Quality Monitoring in a Refinery” IEEE transactions and measurement, vol. 56 NO 1, pages 95-101, February 2007, describes a virtual instrument for estimation of the octane number of gasoline in a refinery.

US2006045801 A1, Boyden et al, describes a controller for directing operation of an air pollution control system performing a process to control emissions of a pollutant with multiple process parameters.

There is a need for a system that is simpler to implement, more accurate, more robust and more stable than the above referenced systems for the measurement of particulates (PM).

### SHORT SUMMARY OF THE INVENTION

The present invention solves the problems of accuracy, robustness, stability and simplicity of a virtual sensor suitable for air quality measurements of particulate matter resulting from man made and/or natural processes by a combination of empirical modelling with ensemble modelling.

In an embodiment the present invention is a virtual sensor system for the estimation of an amount or concentration of particulate matter resulting from natural or man made processes, where said virtual sensor system comprises;
two or more empirical models where each of the empirical models are arranged for being trained using empirical data from the processes, and further arranged for receiving one or more signal input values from one or more sensors of the processes, and for calculating a signal output value based on the signal input values where the signal output value represents an intermediate amount or concentration of PM,
a combination function arranged for receiving the signal output values and continuously calculating a virtual sensor output value as a function of the signal output values, wherein the virtual sensor output value represents the amount or concentration of PM.

In an embodiment the present invention is a method for the estimation of an amount or concentration of particulate matter resulting from natural or man made processes comprising;
receiving in a virtual sensor system (VS) one or more signal input values from one or more sensors comprising the following steps;
training an ensemble of empirical models in the virtual sensor system (VS) with empirical data from the processes,
feeding the trained empirical models with the one or more signal input values from one or more sensors of the processes,
performing calculations of signal output values in the empirical models based on the signal input values, wherein the signal output values represents an intermediate amount of particulate matter,
continuously combining the signal output values and calculating a virtual sensor output value as a function of the signal output values, wherein the virtual sensor output value represents the amount or concentration of particulate matter.

In an embodiment of the invention one or more of the input values represent one or more of meteorological data, traffic measurements, combustion process measurements etc. In an embodiment one or more of the input values are location specific data such as geographical data, time of day, population density etc. By combining e.g. demographical, geographical and other data with data from main contributors to particulate matters, such as combustion processes in process plants, improved estimation of particulate matter (PM) is made possible by estimating specific values for each local area within larger geographical areas, where the sources for particulate matter may be independent of the local areas that the estimation is made for. E.g. traffic density and humidity may contribute specifically to an area one specific day in one specific local area, that is otherwise dominated by particulate matter from a more distant power plant.

In an embodiment of the invention the combination function (f) is arranged for continuously calculating the virtual sensor output value (y_{R}) as an average value of the signal output values (y₁, y₂, . . . , yₙ). The average value can be calculated as a geometrical or arithmetical mean value of the signal output values (y₁, y₂, . . . , yₙ) or a median value.

It is shown that the average calculation, in addition to be easy to implement also makes it possible to achieve a required accuracy that may not be possible with single-node virtual sensors.

In an embodiment of the present invention all the empirical models or inner nodes may have identical structure. This setup has the advantage that the required number of inner nodes can simply be instantiated in the virtual sensor system based on a template node. Further, the nodes may all be arranged for receiving the same set of signal input values from the sensors. Signals from the sensors are distributed to all the nodes, and the extra work of handling special cases is avoided.

In an embodiment the accuracy of the virtual sensor system according to the invention may be increased by instantiating a larger number of empirical models. Thus, it is not necessary to increase the complexity of the system to increase the accuracy. This way of achieving a better result simply by increasing the size of the ensemble is different from other methods that e.g. emphasise the selection of the ensemble.

The improved accuracy of a system according to the invention has been verified in real-life tests. One test including 12 input parameters showed a 10% improvement in the accuracy of the PM measurements as opposed to the mean value of individual sensors.

### BRIEF DESCRIPTION OF THE DRAWINGS

FIG. 1 shows in a block diagram an embodiment of a virtual sensor system according to the invention.

FIG. 2 shows in a graph the comparison between 50 individual estimates (light red), the actual value (green bold), and the ensemble output (blue).

FIG. 3 shows the performance in ppm of an embodiment of a virtual sensor system according to the invention measuring NOx with increasing ensemble size to the right.

FIG. 4 shows PEMS (Predictive Emission Monitoring Systems) performance on test data for 10 inputs.

FIG. 5 shows PEMS performance on test data for 8-inputs.

FIG. 6 shows the comparison between 728 individual outputs, actual value, and ensemble output.

FIG. 7 shows the Mean Absolute Error (MAE) for the ensemble in an embodiment of a virtual sensor system according to the invention.

FIG. 8 shows how virtual sensor systems can be concatenated according to an embodiment of the invention.

### DESCRIPTION OF THE EMBODIMENTS OF THE INVENTION

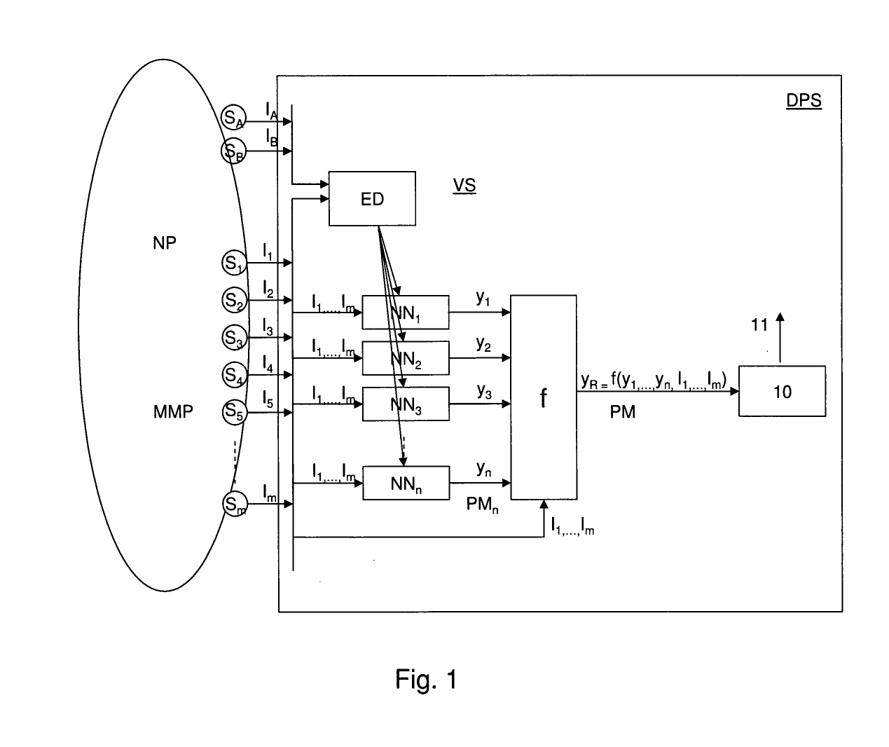

FIG. 1 is a block diagram of an embodiment of a virtual sensor system according to the present invention used to measure the air quality, and more specifically the amount or concentration of particulate matter (PM). Examples of sources for particulate matter (PM) may be natural processes (NP) such as e.g. volcanoes, dust storms, fires, or man made processes (MMP) such as e.g. combustion processes for transport and various production processes.

According to the invention the concentration of particulate matter (PM) can be estimated measuring a combination of two or more parameters from different processes influencing the air quality, and specifically particulate matter (PM), such as meteorological processes, demographics, time of day, traffic concentration etc. In areas where industry is contributing to pollution, combustion process measurements directly related to each combustion process may be used as input parameters for the estimation of particulate matter (PM).

In an embodiment the present invention is a data processing system (DPS) for the estimation of an amount or concentration of particulate matter (PM) resulting from natural processes (NP) or man made processes (MMP). The data processing system (DPS) comprises an ensemble based virtual sensor system (VS) comprising;
two or more empirical models (NN₁, NN₂, . . . , NNₙ), where each of the empirical models (NN₁, NN₂, . . . , NNₙ) are arranged for being trained using empirical data (ED) from the processes (NP, MMP), and further arranged for receiving one or more signal input values (I₁, I₂, . . . , Iₘ) from one or more sensors (S₁, S₂, . . . , Sₘ) of the processes (NP, MMP) and for calculating a signal output value (y₁, y₂, . . . , yₙ) based on the signal input values (I₁, I₂, . . . , Iₘ) wherein the signal output value (y₁, y₂, . . . , yₙ) represents an intermediate amount of particulate matter (PMₙ). It also comprises a combination function (f) arranged for receiving the signal output values (y₁, y₂, . . . , yₙ) and continuously calculating a virtual sensor output value (y_{R}) as a function of the signal output values (y₁, y₂, . . . , yₙ), wherein the virtual sensor output value (y_{R}) represents the amount or concentration of particulate matter (PM).

The estimate of the amount of PM represented by the virtual sensor output value (y_{R}) is more accurate than the signal output value (y₁, y₂, . . . , yₙ) representing an intermediate amounts of particulate matter (PMₙ) from each of the individual empirical models (NN₁, NN₂, . . . , NNₙ). The amount of particulate matter (PM) can be given as the concentration or mass emission as understood by a person with ordinary skills in the art.

More specifically, in this embodiment of the invention each of the empirical models (NN₁, NN₂, . . . , NNₙ) are arranged for being trained using empirical data (ED) resulting from natural processes (NP) or man made processes (MMP). In an embodiment of the invention the empirical data are historical measurement data from where the virtual sensor system (VS) is arranged. The empirical data (ED) of the un-measured quantity can be derived either from actual measurement campaigns with temporarily installed sensor systems (S_{A} and S_{B}) with sensor values (I_{A} and I_{B}) as well as in combination with fixed sensors (S₁, S₂, . . . , Sₘ) as shown in FIG. 1, from records of laboratory analyses, or from detailed estimations with complex analytical models that are computationally too expensive to run on-line. However training data can also be from other similar processes as can be understood by a person skilled in the art. The training data may be the same for all empirical models (NN₁, NN₂, . . . , NNₙ), or different, where e.g. not all process measurements are included for the training data of each of the empirical models (NN₁, NN₂, . . . , NNₙ). This is one way of providing diversity amongst the empirical models (NN₁, NN₂, . . . , NNₙ). They may also be initialized differently by setting different initialization parameters as can be understood by a person skilled in the art.

Each empirical model is further arranged for receiving one or more signal input values (I₁, I₂, . . . , Iₘ) from one or more sensors (S₁, S₂, . . . , Sₘ, and for calculating a signal output value (y₁, y₂, . . . , yₙ) based on the signal input values (I₁, I₂, . . . , Iₘ) where the signal output value (y₁, y₂, . . . , yₙ) from each of the empirical models (NN₁, NN₂, . . . , NNₙ) represents said amount of PM. In addition the virtual sensor system (VS) comprises a combination function (f) arranged for receiving the signal output values (y₁, y₂, . . . , yₙ) from each of the empirical models and continuously calculating a virtual sensor output value (y_{R}) as a function of the signal output values (y₁, y₂, . . . , yₙ), where the virtual sensor output value (y_{R}) represents the amount of PM.

In an embodiment the invention is a method for the estimation of an amount of particulate matter (PM) resulting from natural processes (NP) or man made processes (MMP) comprising the following steps;
receiving in a virtual sensor system (VS) in a data processing system (DPS) one or more signal input values (I₁, I₂, . . . , Iₘ) from respective one or more sensors (S₁, S₂, . . . , Sₘ),
training an ensemble of empirical models (NN₁, NN₂, . . . , NNₙ) in the virtual sensor system (VS) with empirical data from the processes (NP, MMP),
feeding the trained empirical models (NN₁, NN₂, . . . , NNₙ) with the one or more signal input values (I₁, I₂, . . . , Iₘ) from the respective one or more sensors (S₁, S₂, . . . , Sₘ).
performing calculations of signal output values (y₁, y₂, . . . , yₙ) in each of the empirical models (NN₁, NN₂, . . . , NNₙ) based on the signal input values (I₁, I₂, . . . , Iₘ) wherein each of the signal output values (y₁, y₂, . . . , yₙ) represents an intermediate amount of particulate matter (PMₙ),
continuously combining the signal output values (y₁, y₂, . . . , yₙ) and calculating a virtual sensor output value (y_{R}) as a function of the signal output values (y₁, y₂, . . . , yₙ), wherein the virtual sensor output value (y_{R}) represents the amount of particulate matter (PM).

In an embodiment of the invention one or more of the input values (I₁, I₂, . . . , Iₘ) represent one or more of meteorological data, traffic measurements, combustion process measurements etc. In an embodiment one or more of the input values (I₁, I₂, . . . , Iₘ) are location specific data such as geographical data, time of day, population density etc. By combining e.g. demographical, geographical and other data with data from main contributors to particulate matters, such as combustion processes in process plants, improved estimation of particulate matter (PM) is made possible by estimating specific values for each local area within larger geographical areas, where the sources for particulate matter may be independent of the local areas that the estimation is made for. E.g. traffic density and humidity may contribute specifically to an area one specific day in one specific local area, that is otherwise dominated by particulate matter from a more distant power plant.

In an embodiment of the present invention all the empirical models (NN₁, NN₂, . . . , NNₙ) or inner nodes may have identical structure. This setup has the advantage that the required number of inner nodes can simply be instantiated in the virtual sensor system based on a template node. In this embodiment also the format of corresponding inputs and outputs of the empirical models may be identical, i.e. the format of input 1 on empirical model NN₁ is the same as the format of input 1 on empirical model NN₂ to NNₙ etc.

The nodes may all be arranged for receiving the same set of signal input values (I₁, I₂, . . . , Iₘ) from the sensors (S₁, S₂, . . . , Sₘ) of the natural processes (NP) and/or man made processes (MMP) Signals from the sensors are distributed to all the nodes, and the extra work of handling special cases is avoided.

Empirical modelling has been described previously in this document and can be implemented using different techniques. In an embodiment of the invention the empirical models are neural networks.

The combination function (f) of the virtual sensor system may be arranged to calculate the output value (y_{R}) based on different criteria's. In an embodiment of the present invention the combination function (f) is arranged for continuously calculating the virtual sensor output value (y_{R}) as an average value of the signal output values (y₁, y₂, . . . , yₙ). The average value can be calculated as a geometrical or arithmetical mean value of the signal output values (y₁, y₂, . . . , yₙ) a median value or a combination of mean and median, such as the average of the two middle values. It can be shown that the performance of a virtual sensor system according to the invention with median value calculation in most cases is better than the mean value calculation due to the fact that the output is generally not affected by individual noise or irregularities when the median value calculation is used.

This approach counteracts the intrinsic variance that one can expect in the performance of empirical regression models such as neural networks. The origin of this variance can stem from various degrees of overfitting of the training data (i.e. resulting in modelling the noise in the data), from the typically random initialization of the neural network parameters before training, and from the non-deterministic gradient descent techniques used for fitting the neural network model to the data.

In one embodiment of the invention the virtual sensor system (VS) comprises a notification function (10) arranged for receiving the sensor output value (y_{R}) and further arranged for sending a notification message (11) when the concentration of PM increases above a predefined threshold, as can be seen in FIG. 1. When a number of instruments for monitoring the concentration of PM based on the virtual sensor system according to the invention are distributed over larger areas, such as a for city, along roads, near industrial areas etc, the instant notification of high PM concentrations can be transmitted to a set of predefined recipients, e.g. environmental authorities, police, fire brigades, etc. over open or restricted networks in the form of e-mail, SMS, DAB radio signals, etc. Such notifications can also be used to update information appearing in web pages, traffic signs, etc. to automatically divert traffic away from areas with high concentration, reduce pollution by implying restrictions on the use of cars or outlets from factories in an area, or warn the public at risk, e.g. asthmatics about high particle concentrations.

The threshold level for sending a notification may be set individually for the different particles in the composition measured.

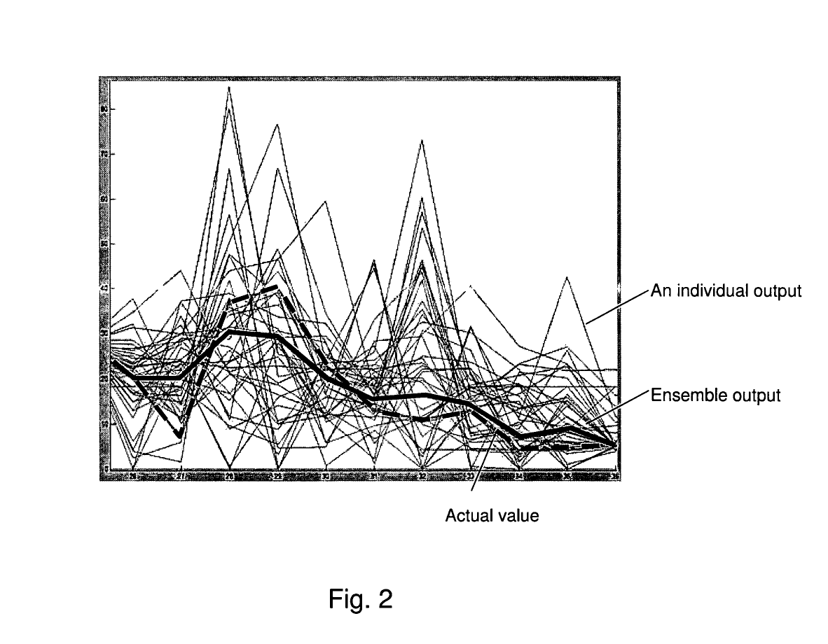

FIG. 2 illustrates the kind of variance that can result from a combination of these factors, a set of neural network virtual sensor models were developed and the figure shows the individual outputs of 50 models, the actual expected value being estimated, and the ensemble combination of the 50 individual estimates.

In an embodiment of the present invention the combination function (f) is arranged for receiving one or more of said signal input values (I₁, I₂, . . . , Iₘ) directly from the process sensors (S₁, S₂, . . . , Sₘ) in addition to the signal output values (y₁, y₂, . . . , yₙ) from the empirical models (NN₁, NN₂, . . . , NNₙ) and calculating a virtual sensor output value (y_{R}). In this embodiment of the invention the signal output values (y₁, y₂, . . . , yₙ) are individually, dynamically weighted based on the one or more signal input values (I₁, I₂, . . . , Iₘ). Dynamic weighting may reduce the impact on the virtual sensor output value from noise and disturbances related to one or more of the sensors or transmission lines from the sensors. In a related embodiment of the invention the combination function (f) is an empirical model (NN_{R}) arranged for receiving the signal input values (I₁, I₂, . . . , Iₘ) and calculating a virtual sensor output value (y_{R}) based on the signal output values (y₁, y₂, . . . , yₙ), the signal input values (I₁, I₂, . . . , Iₘ) and the structure of the empirical model (NN_{R}).

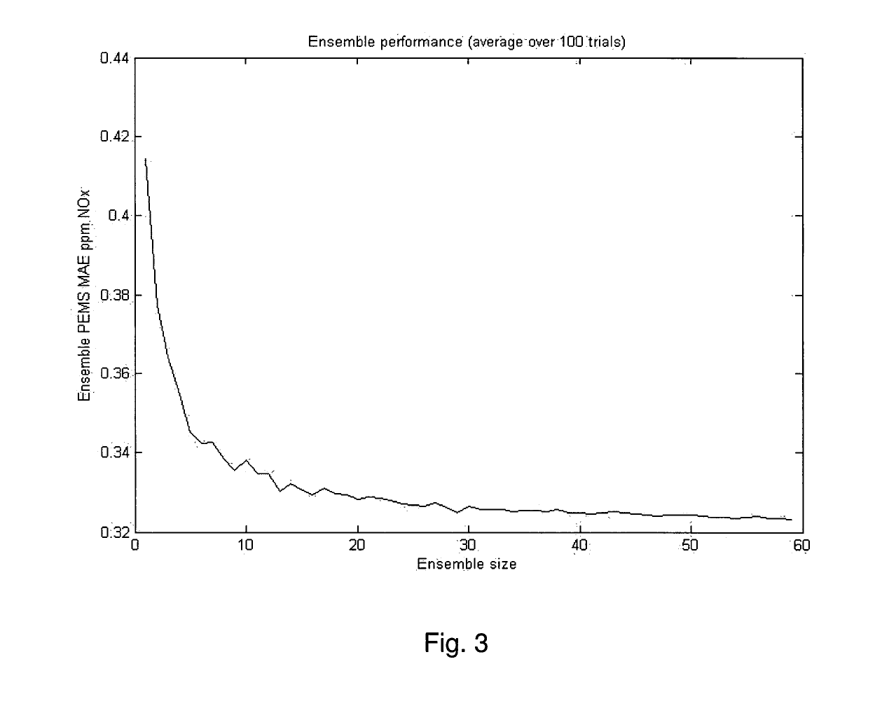

FIG. 3 shows how the performance or accuracy of an embodiment of a virtual sensor system (VS) here used for NOx measurement, increases with the number of nodes. The performance requirement for a virtual sensor system in a given application may vary, and an unnecessary large number of nodes may slow down the initialization process of the virtual sensor system (VS). In an embodiment of the present invention the virtual sensor system (VS) is arranged for being able to instantiate a number of said empirical models (NN₁, NN₂, . . . , NNₙ) to accommodate specific performance criteria's. In an embodiment of the invention the virtual sensor system (VS) is arranged for dynamically allocating the required number of said empirical models (NN₁, NN₂, . . . , NNₙ) to achieve the predefined performance requirement of the virtual sensor output value (y_{R}) representing the amount of PM.

According to the invention a data processing system (DPS) comprises the virtual sensor system (VS). The data processing system (DPS) may be distributed over a data network comprising one or more data processors or computational devices. In an embodiment each of the empirical models (NN₁, NN₂, . . . , NNₙ) and the combination function (f) may be distributed over more than one data processor or computational device.

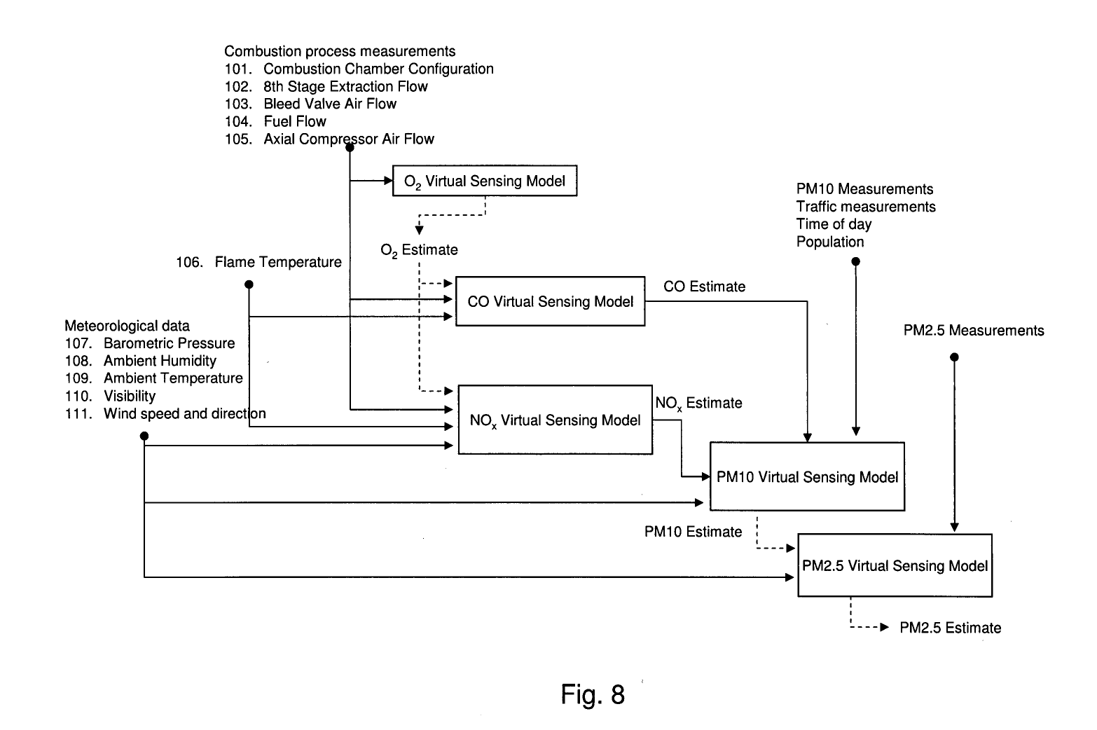

In an embodiment of the invention virtual sensor systems (VS) may be concatenated as can be seen from FIG. 8. Here it is shown how O2 from a combustion process is estimated in a virtual sensor system. The O2 concentration is estimated based on Combustion Chamber Configuration, 8th Stage Extraction Flow, Bleed Valve Air Flow, Fuel Flow and Axial Compressor Air Flow. The estimated O2 concentration is used as an input to the NOx Virtual sensor system together with these additional process measurement values; Flame Temperature, Barometric Pressure, Ambient Humidity and Ambient Temperature. The Estimates for O2 and NOx in FIG. 8 may be used as input for estimating PM according to the invention. In FIG. 8 it is shown how PM10 estimates are used as one of several inputs for the PM 2.5 virtual sensor according to the invention. However, in an embodiment the PM10 and/or PM PM2.5 estimates may be used as input for the estimation of PM1.

In addition to the CO and NOx estimates from separate virtual sensing models, the other input could be from measurements stations for PM 2.5 and PM10, Air quality models, Relevant local emission related data, traffic, and population density information, as well as meteorological data such as visibility, wind speed and direction, pressure, temperature, humidity etc. Time of day and date may be relevant inputs for improving quality of the estimates.

In an embodiment of the invention the virtual sensor system is arranged for the estimation of PM1 values.

Concatenation of virtual sensor systems may improve the performance of the system as well as simplify the structure of the empirical models, and the training of the system.

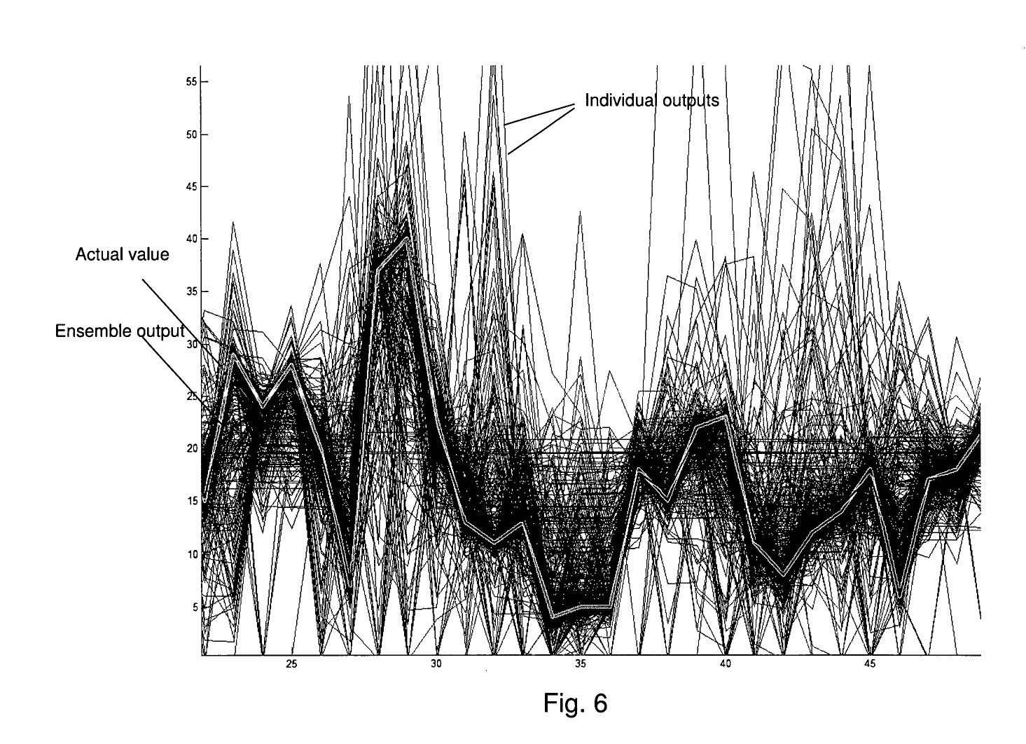

Tests of the present invention using different ensemble sizes have shown that ensemble performance improves with increasing ensemble size. This way of achieving a better result simply by increasing the size of the ensemble is different from other methods that e.g. emphasize the selection of the ensemble. In these tests ensemble size was varied from a minimum of 2 component models to a maximum of 59 component models. For each ensemble size, 100 individual trials were conducted and the resulting performance (expressed as Mean Absolute Error) was calculated. The collected results are summarised in FIG. 3, showing that values are tapering out at ensemble sizes of about 20-30 individuals. FIG. 6 shows an extreme case with more than 700 outputs.

PEMS (Parametric Emission Monitoring System) technology was originally developed to have a more cost effective alternative to CEMS (Continuous Emission Monitoring System) for monitoring the nitrogen oxides (NOX) emissions of gas turbines. A CEMS is the total equipment necessary for the determination of gas or particulate matter concentration or emission rate, using physical pollutant analyser measurements. Instead of directly measuring the PM emissions, a PEMS calculates the emissions from key operational parameters and can therefore be considered in all respects a virtual sensor.

To illustrate the quality of the estimates from the virtual sensing technology according to the invention a PEMS for NOx estimation was developed, where a number of models are individually constructed and then combined in an aggregated ensemble model. In this case the ensemble PEMS model was a combination of 20 individual PEMS models.

In order to train and test these models, the original dataset of 5 hours of process and emissions data was split into a training set, a validation set, and a test set, where the training set was used to build the models, the validation set to control the modelling (i.e. to avoid overfitting the models to the training data), and the test set to evaluate model performance.

To split the original dataset, 40% of the data was randomly selected for training, 30% was randomly selected for validation, and the remaining 30% was kept for testing.

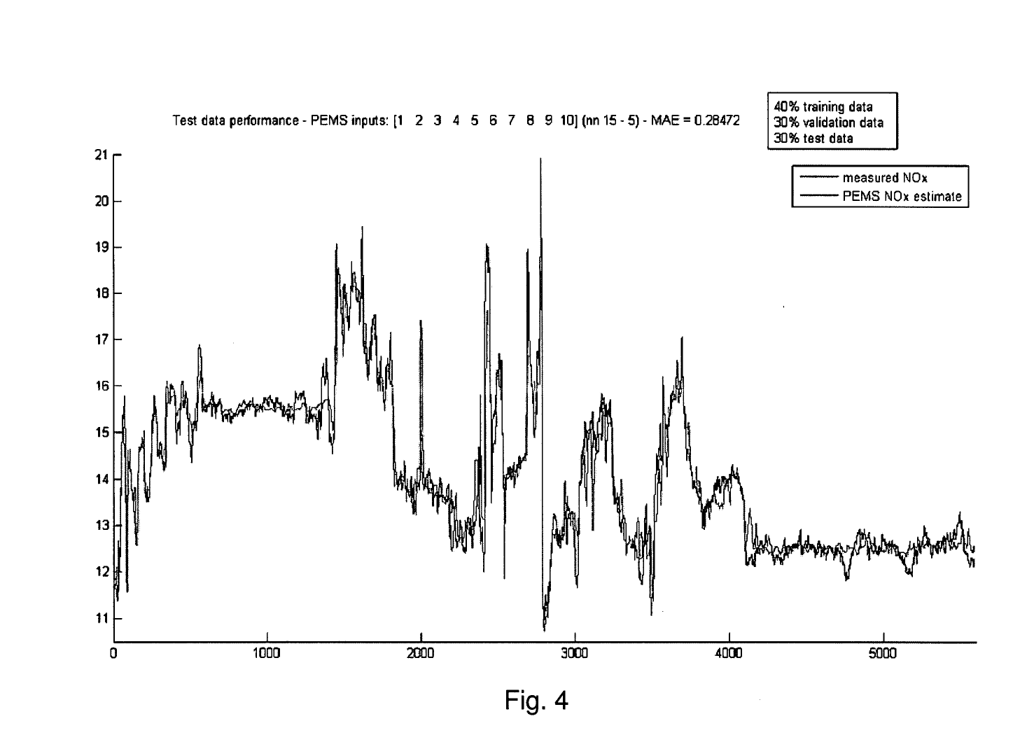

The results of the PEMS performance on the test dataset (i.e. data not used during training to build the model) are shown graphically in FIG. 4, and give a Mean Absolute Error of 0.28472 ppm, where:

$$MAE = \frac{{\sum }_{i = 1}^{N} \vert {y}_{i} - {\hat{y}}_{i} \vert}{N}$$

and yⁱ is the expected value and ŷⁱ is the model estimate.

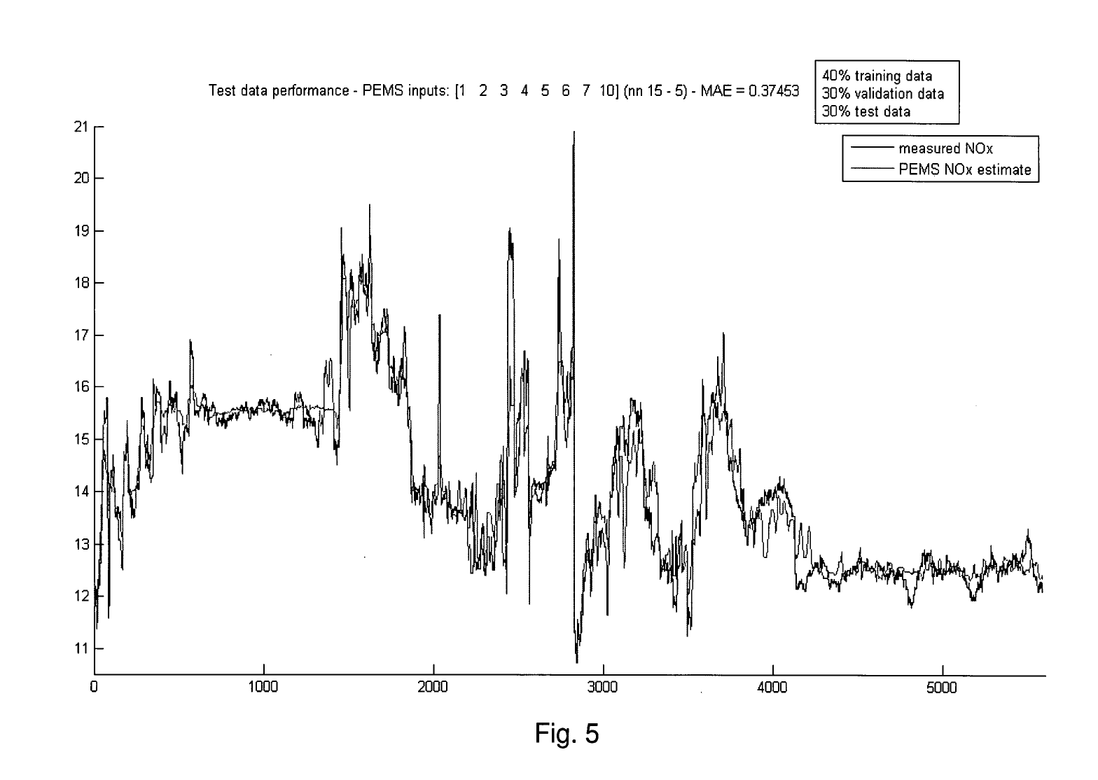

In order to explore the feasibility of this PEMS approach, only 8 measurements were taken in input as shown in FIG. 5.

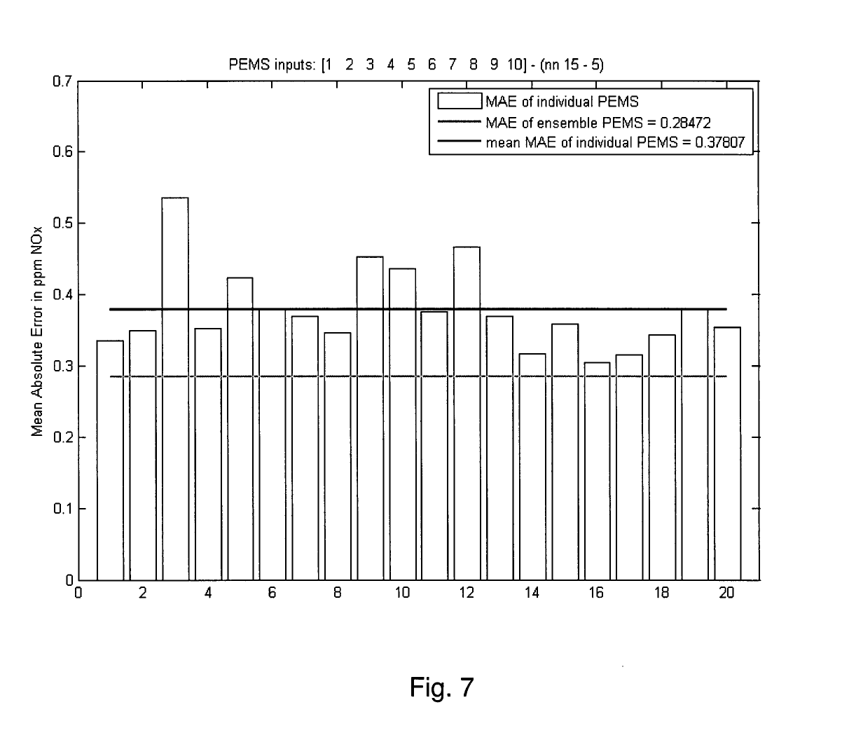

The results of the PEMS performance on the test dataset for this case are shown graphically in FIG. 7, and give a MAE of 0.37453 ppm.

The average error of the PEMS with 8 inputs is about 30% higher than the average error of the PEMS with all 10 inputs.

In one embodiment there is a high similarity between the training and the test data. Even though training and test data are completely disjoints data sets (having these been randomly drawn, without replacement, from the original data set), they are still obtained from the same time series, and the likelihood that a point in the test set has a very similar point in the training set is very high. This notwithstanding, the level of accuracy is sufficiently large to grant a certain degree of confidence in this embodiment.

In another embodiment a plurality of models are generated and a mechanism is used for selecting particular models to be part of the ensemble. This is done either statically i.e. only once after the training phase, discarding unwanted models at the outset, or dynamically, i.e. introducing a weighing scheme that, given the current operational state, favours component models that have a demonstrated a better performance in or near that operational state.

In yet another embodiment hybrid ensemble models are used, i.e. ensembles where the component models are not necessarily of the same type but consist for example of neural networks as well as other regression models or a combination of empirical and analytical models.

1. A data processing system (DPS) for the estimation of an amount or concentration of particulate matter (PM) resulting from natural processes (NP) or man made processes (MMP), said data processing system (DPS) comprising an ensemble based virtual sensor system (VS) comprising;
two or more empirical models (NN₁, NN₂, . . . , NNₙ), each of said empirical models (NN₁, NN₂, . . . , NNₙ) arranged for being trained using empirical data (ED) from said processes (NP, MMP), and further arranged for receiving one or more signal input values (I₁, I₂, . . . , Iₘ) from one or more sensors (S₁, S₂, . . . , Sₘ) of said processes (NP, MMP) and for calculating a signal output value (y₁, y₂, . . . , yₙ) based on said signal input values (I₁, I₂, . . . , Iₘ) wherein said signal output value (y₁, y₂, . . . , yₙ) represents an intermediate amount of particulate matter (PMₙ),
a combination function (f) arranged for receiving said signal output values (y₁, y₂, . . . , yₙ) and continuously calculating a virtual sensor output value (y_{R}) as a function of said signal output values (y₁, y₂, . . . , yₙ), wherein said virtual sensor output value (y_{R}) represents said amount or concentration of particulate matter (PM).

2. The virtual sensor system (VS) according to claim 1, wherein all said empirical models (NN₁, NN₂, . . . , NNₙ) have identical structure.

3. The virtual sensor system (VS) according to claim 1, wherein all said empirical models (NN₁, NN₂, . . . , NNₙ) are arranged for receiving the same set of signal input values (I₁, I₂, . . . , Iₘ).

4. The virtual sensor system (VS) according to claim 1, wherein said empirical models (NN₁, NN₂, . . . , NNₙ) are neural networks.

5. The virtual sensor system (VS) according to claim 1, wherein said combination function (f) is arranged for continuously calculating said virtual sensor output value (y_{R}) as an average value of said signal output values (y₁, y₂, . . . , yₙ).

6. The virtual sensor system (VS) according to claim 1, wherein said combination function (f) is arranged for receiving one or more of said signal input values (I₁, I₂, . . . , Iₘ) and calculating a virtual sensor output value (y_{R}) wherein said signal output values (y₁, y₂, . . . , yₙ) are dynamically weighted based on said one or more signal input values (I₁, I₂, . . . , Iₘ).

7. The virtual sensor system (VS) according to claim 1, wherein said combination function (f) is an empirical model (NN_{R}) arranged for receiving one or more of said signal input values (I₁, I₂, . . . , Iₘ) and calculating a virtual sensor output value (yR) based on said signal output values (y₁, y₂, . . . , yₙ), said signal input values (I₁, I₂, . . . , Iₘ) and a structure of said empirical model (NN_{R}).

8. The virtual sensor system (VS) according to claim 1, wherein said sensor is arranged for being able to instantiate a number of said empirical models (NN₁, NN₂, . . . , NNₙ) to achieve a predefined performance requirement of said virtual sensor output value (y_{R}).

9. The virtual sensor system (VS) according to claim 1 arranged for being concatenated, wherein one or more of said sensors (S₁, S₂, . . . , Sₘ) are ensemble based virtual sensor systems (VS) for the estimation of an amount or concentration of PM.

10. The virtual sensor system (VS) according to claim 1, comprising a notification function (10) arranged for receiving said sensor output value (y_{R}) and further arranged for sending a notification message (11) when said concentration of PM increases above a predefined threshold.

11. The method according to claim 1, where one or more of said signal input values (I₁, I₂, . . . , Iₘ) are values from one or more of; meteorological data, traffic measurements, combustion process measurements.

12. The method according to claim 1 where one or more of said signal input values (I₁, I₂, . . . , Iₘ) are location specific data such as geographical data, time of day, population density etc.

13. A method for the estimation of an amount of particulate matter (PM) resulting from natural processes (NP) or man made processes (MMP) comprising the following steps;
receiving in a virtual sensor system (VS) in a data processing system (DPS) one or more signal input values (I₁, I₂, . . . , Iₘ) from respective one or more sensors (S₁, S₂, . . . , Sₘ),
training an ensemble of empirical models (NN₁, NN₂, . . . , NNₙ) in said virtual sensor system (VS) with empirical data from said processes (NP, MMP),
feeding said trained empirical models (NN₁, NN₂, . . . , NNₙ) with said one or more signal input values (I₁, I₂, . . . , Iₘ) from said respective one or more sensors (S₁, S₂, . . . , Sₘ),
performing calculations of signal output values (y₁, y₂, . . . , yₙ) in each of said empirical models (NN₁, NN₂, . . . , NNₙ) based on said signal input values (I₁, I₂, . . . , Iₘ) wherein each of said signal output values (y₁, y₂, . . . , yₙ) represents an intermediate amount of particulate matter (PMₙ),
continuously combining said signal output values (y₁, y₂, . . . , yₙ) and calculating a virtual sensor output value (y_{R}) as a function of said signal output values (y₁, y₂, . . . , yₙ), wherein said virtual sensor output value (y_{R}) represents said amount of particulate matter (PM).

14. The method according to claim 13, wherein all said empirical models (NN₁, NN₂, . . . , NNₙ) have identical structure.

15. The method according to claim 13, comprising the step of feeding all said empirical models (NN₁, NN₂, . . . , NNₙ) with the same set of signal input values (I₁, I₂, . . . , Iₘ).

16. The method according to claim 13, wherein said empirical models (NN₁, NN₂, . . . , NNₙ) are neural networks.

17. The method according to claim 13, comprising the step of continuously calculating said virtual sensor output value (y_{R}) representing the amount of PM as an average value of said signal output values (y₁, y₂, . . . , yₙ).

18. The method according to claim 13, comprising the step of continuously receiving one or more of said signal input values (I₁, I₂, . . . , Iₘ) and calculating a virtual sensor output value (y_{R}) wherein said signal output values (y₁, y₂, . . . , yₙ) are dynamically weighted based on said one or more signal input values (I₁, I₂, . . . , Iₘ).

19. The method according to claim 13, comprising the step of receiving one or more of said signal input values (I₁, I₂, . . . , Iₘ) and calculating a virtual sensor output value (y_{R}) based on said signal output values (y₁, y₂, . . . , yₙ), said signal input values (I₁, I₂, . . . , Iₘ) and a structure of said empirical model (NN_{R}).

20. The method according to claim 13, comprising the step of calculating a required number of said empirical models (NN₁, NN₂, . . . , NNₙ) based on a predefined performance requirement of said virtual sensor output value (y_{R}).

21. The method according to claim 13 being recursive in that one or more of said signal input values (I₁, I₂, . . . , Iₘ), themselves are virtual sensor output values (y_{R}) from a method according to claim 13.

22. The method according to claim 13, comprising the step of sending a notification message (11) when said concentration of PM increases above a predefined threshold.
